(19) United States
(12) Patent Application Publication
(10) Pub. No.: US 2018/0341899 A1
(43) Pub. Date: Nov. 29, 2018

(54) PREDICTIVE AND ADAPTIVE RESOURCE PROGRAM MANAGEMENT SYSTEM USING CONTINUOUS DATA STREAMS AND RELATED METHODS OF USE

(71) Applicant: Institutional Shareholder Services Inc., Rockville, MD (US)

(72) Inventor: Thomas YARNALL, Kensington, MD (US)

(73) Assignee: Institutional Shareholder Service Inc.

(21) Appl. No.: 15/989,937

(22) Filed: May 25, 2018

Related U.S. Application Data
(60) Provisional application No. 62/511,843, filed on May 26, 2017.

(51) Int. Cl. G06Q 10/06; G06Q 20/10

(52) U.S. Cl. CPC G06Q 10/06315; G06Q 20/10; G06Q 10/06398; G06Q 10/0635

(57) ABSTRACT

Systems and methods for online evaluation, selection, optimization and monitoring of organizations compensation program metrics are disclosed. A computer-implemented method for online incentive program optimization is disclosed. The method includes receiving over a network and from an administrator of an incentive program information relating to revenue, earnings before interest and taxes, revenue growth, earnings before interest and taxes growth, net income and other organizational goals. The method further includes using a processor to analyze the information relating to the organization's incentive program: (1) calculating the correlation between compensation program metrics and total shareholder return for the organization, (2) calculating the historical volatility of the compensation metrics, (3) evaluating relationships between metric total shareholder return (TSR) correlation and metric volatility, and (4) determining the mix of metrics that maximize TSR correlation and minimize metric volatility, generating a recommended adjustment of incentive program criteria and weights or weightings of incentive program metrics.

### RELATED APPLICATION

This application claims priority to U.S. Provisional Application No. 62/511,843 filed May 26, 2017, the entire disclosure of which is hereby incorporated by reference in its entirety.

### TECHNICAL FIELD

The present disclosure relates generally to generating and presenting a dynamic user interface by obtaining and processing data to design incentive compensation awards and recommendations for managing user-defined goals over the Internet. Various embodiments of the present disclosure relate generally to computerized systems and methods for organization incentive award metric evaluation, selection, recommendation, and monitoring by communicating information over the Internet to present a dynamic user interface. More specifically, particular embodiments of the present disclosure relate to systems and methods for generating and presenting a dynamic user interface including selecting and displaying optimized compensation metrics by communicating electronic information over the Internet.

### BACKGROUND

An organization's incentive program is a formal scheme used to promote or encourage specific actions or behavior by a specific group of employees, such as executives in a company, during a defined period of time. Corporate incentive programs are used to motivate employees to achieve certain goals, such as sales or earnings targets, by tying resource allocation to the achievement of these targets. In some examples, these targets are meant to align executive compensation with a company's financial performance; a concept known as “pay-for-performance.” Sometimes, corporate resource allocation, such as allocation driven by a corporate incentive program, does not align well with shareholder interests. For example, a company's sales may not increase similarly to the same company's stock price (or Total Shareholder Return—“TSR”), allowing for more resources to be allocated to an executive's compensation compared to the resources allocated to shareholders. Current resource allocation advisory services do not provide real-time updates and recommendations for incentive program metric optimization over the Internet by utilizing metric optimization algorithms and historical award metric databases to reach user defined goals. There is a need for organization leaders, such as corporate directors or management employees, to have a system to receive real-time recommendations for resource allocation, including incentive program metric optimization, based on current metric values, metric weights, historical data, and user defined goals, such as high correlation between incentive program metrics and TSR. Furthermore, volatility in incentive program metric correlation to shareholder return creates uncertainty and there is a need to minimize metric volatility through real-time monitoring and optimization of incentive program metrics. In order to avoid a disconnect between corporate incentive programs and TSR, real-time monitoring of incentive program metric correlation to TSR, among other user defined factors, is needed. There is a need for a system to generate and display on a dynamic user interface real-time optimization of compensation program metrics and metric alignment with shareholder returns. Also, there is a need for a system to generate and display compensation program metric alignment against the probability that they could cause a pay-for-performance disconnect between executives (or corporate management) and shareholders. Moreover, there is a need for a system to receive user customized inputs of resource allocation metrics, display resource allocation correlation to TSR or other metrics, and display recommended adjustments to resource allocation metrics.

The disclosed embodiments of the present disclosure are directed to overcoming one or more of the problems set forth above. The disclosed embodiments include computerized systems and methods for online corporate incentive program metric optimization.

### SUMMARY

According to an exemplary embodiment, a method is disclosed for online incentive program optimization. The method includes receiving, over a network and from an administrator of an organization's incentive program, information relating to the organization's key financial metrics (such as revenue, earnings before interest and taxes, net income, and other internal organizational goals measured on either an absolute or percentage change basis). The method further includes using a processor to analyze the information relating to the organization's incentive program; optimize correlation between the information and total shareholder return or any other selected metric; and generate a recommended set of incentive program metrics and weights or weightings of incentive program metrics. The method further includes transmitting the recommended metrics and metric weights over the network; displaying the recommended metrics and metric weights in a dynamic user interface; and receiving payment from an administrator of the organization's incentive program or resource allocation program, the payment being provided in consideration for the recommended incentive program metrics and criteria.

According to one exemplary embodiment of the disclosure, a system for online optimization of compensation program metrics is disclosed. The system includes a physical storage media storing instructions for optimizing compensation program metrics. The system further includes a processor configured for: receiving, over a network and from an organization with a compensation program, information relating to the compensation program; analyzing the information relating to the compensation program; generating recommended adjustments to the compensation program; transmitting the recommended adjustments to the compensation program to the organization over the network; and receiving payment from the organization, the payment being provided in consideration for the recommended adjustments to the compensation program.

Additional embodiments and advantages will be set forth in part in the description which follows, and in part will be obvious from the description, or may be learned by practice of the disclosure. The embodiments and advantages will be realized and attained by means of the elements and combinations particularly pointed out below.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of a method to optimize incentive award metrics, according to an exemplary embodiment of the present disclosure.

FIG. 2 is a schematic diagram of an environment in which award program metrics may be monitored and optimized, according to an exemplary embodiment of the present disclosure.

FIG. 3 is a diagram of a method for incentive program optimization, according to an exemplary embodiment of the present disclosure.

FIG. 4 is a block diagram of an exemplary electronic network and environment for processing incentive program metric data and optimizing inventive program metrics, according to an exemplary embodiment of the present disclosure.

FIG. 5 is a dynamic user interface, according to an exemplary embodiment of the present disclosure.

FIG. 6 is a dynamic user interface, according to an exemplary embodiment of the present disclosure.

FIG. 7 is a dynamic user interface, according to an exemplary embodiment of the present disclosure.

FIG. 8 is a dynamic user interface, according to an exemplary embodiment of the present disclosure.

FIG. 9 is a dynamic user interface, according to an exemplary embodiment of the present disclosure.

FIG. 10 is a dynamic user interface, according to an exemplary embodiment of the present disclosure.

FIG. 11 is a dynamic user interface, according to an exemplary embodiment of the present disclosure.

FIG. 12 is an output report, according to an exemplary embodiment of the present disclosure.

FIGS. 13A-13G are an output report, according to an exemplary embodiment of the present disclosure.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

In view of the challenges outlined above, systems and methods are disclosed for enabling organizations to generate optimized incentive metrics to increase alignment with target outcomes (such as shareholder return) while minimizing metric volatility based on known historical data and real-time data tracking, such as periodic monitoring of revenue, earnings before interest and taxes (EBIT), revenue growth, EBIT growth, net income, etc. For example, systems and methods are disclosed for enabling an organization's management team to adjust and monitor incentive program metrics based on correlation to total shareholder return (TSR), average growth of TSR, median growth of TSR, volatility of selected metric correlation to TSR, etc. over various time periods (one year, three years, five years, etc.). In one embodiment, systems and methods are disclosed for enabling corporate management to provide real-time optimization of incentive programs through an interactive program and track correlation of incentive program metrics to target milestones or goals (such as a target shareholder return value). More generally, systems and methods are disclosed for recommending incentive program metrics and metric weights based on the processing of company financial data.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

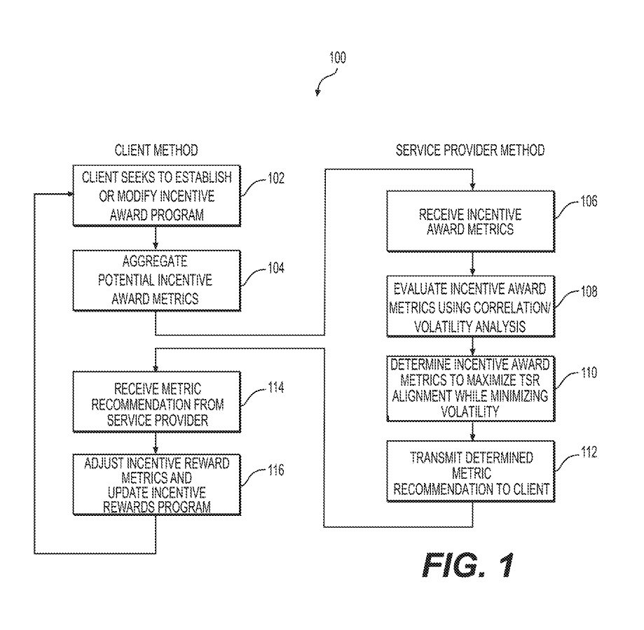

FIG. 1 is a diagram of an exemplary method 100 in which an incentive awards program may be created or optimized according to client specific goals or client metric data, according to an exemplary embodiment of the present disclosure. In some embodiments, client goals or client metric data may be provided to service provider through client periodic interaction with a service provider. Client periodic interaction may be over the internet, through mobile devices, through a private server, or by any other means. In some examples, the depicted method 100 may be used for automated incentive program metric optimization. As shown in FIG. 1, method 100 may include a client seeking to establish or modify a corporate incentive award program 102. The corporate incentive award program 102 may potentially include any number of incentive program metrics, such as total revenue generated during a set period of time, total earnings before interest and taxes (EBIT) during a set period of time, revenue growth, EBIT growth, net income, net sales, cash flow, operating income, net income, earnings per share, economic value added, etc. In some embodiments, the client may establish a potential incentive award program in step 102 (which may establish metrics based on third party recommendations, historical data, interaction with service provider over the internet, internal procedures, or any other means). In other examples, the client may seek to establish an incentive awards program, e.g. provide possible metrics for an awards program and have the service provider create an incentive awards program for the client. After step 102, the client aggregates the historic values for metrics (such as historical revenue growth, etc.) and communicates the aggregated metric values to a service provider in step 104. The potential award metrics data may include client goals or updates to client goals, periodic award program metric values, growth rate of metrics, historical or projected metric data, and any other established metrics. The award metrics data may be electronically transmitted and received by a server, over the Internet, or uploaded to an online database system. For example, the client may use a mobile application or web portal to send or drop electronic data files via a network so that the files may be accessed by the service provider. In some examples, a dynamic user interface may be used to transmit, receive, edit, or upload award metrics data to a remote or online database system. The service provider subsequently receives the potential incentive award program metrics in step 106 and evaluates the incentive award metric data using correlation and/or volatility analysis in step 108.

In step 110, the service provider may determine which award program metrics need to be weighted differently in the client's incentive award program. Also in step 110, the service provider may determine that certain incentive award program metrics should be eliminated from the client's awards program, and/or certain awards program metrics should be added to the awards program. Adjustments to incentive award program metrics may be generated by service provider through algorithms and metric databases to correlate current metric values and weightings with expected shareholder return. In some embodiments, incentive awards program metrics may be recommended by service provider for client to create a new incentive awards program. Award program metric adjustment recommendations may be generated automatically in network server systems and may be transmitted to the client automatically over the Internet (step 112), such as through a dynamic user interface accessed via a computing system. For example, the service provider may generate a recommendation to adjust a target weight of EBIT in an awards program to increase correlation to TSR or minimize volatility of TSR (step 110), and subsequently communicate to the client over the Internet, via a mobile application, automated e-mail or a web portal (step 112), a message to the client recommending that the target weight of the awards program metric of EBIT be increased, e.g., by 20%.

In step 114, the client may receive an awards program metric recommendation or an awards program metric adjustment recommendation from the service provider, via an Internet web portal, integrated software platform, e-mail, or mobile application, and adjust the incentive award program metrics and update the incentive awards program in step 116. In some embodiments, step 116 may include starting a new incentive awards program based on the metric recommendation from service provider in step 114. The client may periodically report the established incentive award program metrics to allow the service provider to continually adjust and update the client's award program metrics for subsequent awards to ensure metric correlation to TSR or other client goals. Method 100 allows the client to receive real-time feedback from service provider on incentive award program correlation between the TSR (or other client goals) and metric selection. In some examples, the client may receive an awards program metric recommendation or an awards program metric adjustment recommendation from a dynamic user interface, which may include or be accessed through one or more of an Internet web portal, integrated software platform, e-mail, or mobile application.

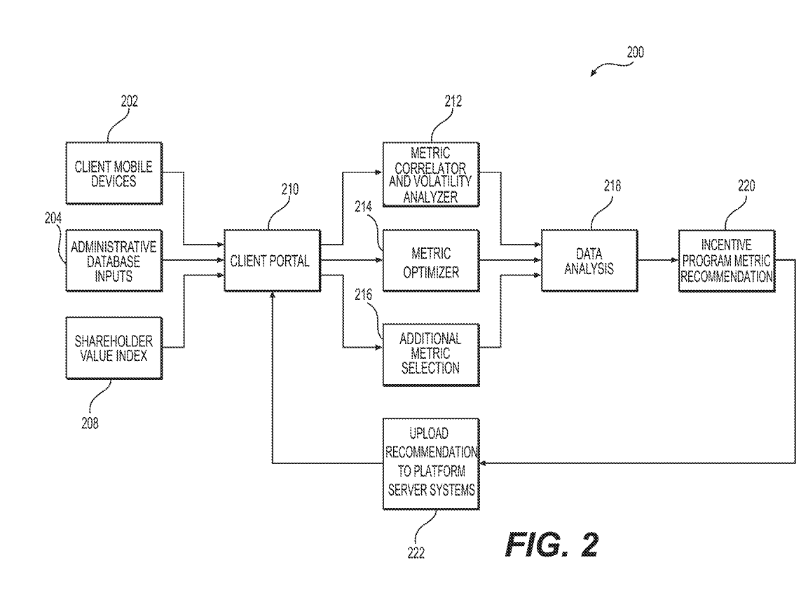

FIG. 2 shows an exemplary method 200 in which an incentive awards program may be optimized according to client specific goals through client periodic interaction with a service provider through a client portal, according to an exemplary embodiment of the present disclosure. For example, a client portal may be a dynamic user interface accessed via a computing system connected to a network. In method 200, the client may input into the client portal 210 incentive awards program metrics through client mobile devices 202, administrative database inputs 204, and a shareholder value index 208. The client may input updated metric data in the incentive program, such as quarterly EBIT values or sales targets from various client departments, through client mobile devices. The client may further input data from administrative databases 204 such as the previous five years of incentive awards program metric data and goals achieved. A shareholder value index 208 may also be linked to the client portal to input the shareholder value of the client's corporation, or an aggregation of the client company's shareholder value, for example through an online system like Bloomberg or other online financial market tracking system. The client portal 210 may be a dynamic user interface accessed through a computing system and may comprise a web platform accessible over the Internet, a mobile platform accessible via a mobile device, and/or a private server platform accessible via a client's internal intraweb.

The client portal 210 of FIG. 2 may have a series of algorithms and databases stored in the portal system to analyze the client's inputs (such as current, historical or potential awards program metric values and metric weightings). The client portal 210 may include a metric correlator and/or volatility analyzer 212 that may compare current and potential awards program metric values and metric weights with historical metric value and weighting data, target metric values, and shareholder return values. The metric optimizer 214 may determine, using a series of algorithms and databases, recommended optimized metrics for the incentive program. The optimized metrics generated by the metric optimizer 214 may be used to recommend adjustments to an existing incentive program or to generate a new inventive program. In some embodiments, additional metric selection 216 may occur to add additional metrics to the existing client metrics, or add additional metrics different from the metrics provided by the client through the client portal 210. Shareholder return values may be provided to the client portal 210 system through a shareholder value index 208, a historical database on shareholder return values, input from client mobile devices 202 or administrative databases 204 of total shareholder return values, or other means.

The client portal 210 may provide data analysis 218 by creating a report of awards program metric progress, correlation of awards program metrics to TSR, current progress towards client goals, and other correlations of metrics to possible target values generated by the client portal. During step 218, the client portal 210 may run a series of algorithms to calculate metric adjustment weights to optimize TSR alignment, minimize metric volatility, or achieve a client target value for specific awards program metrics. In some embodiments, during step 218 the client portal 210 may run additional algorithms to calculate additional metric values and recommend adding additional metrics to optimize TSR alignment, minimize metric volatility, or achieve a client target value for specific awards program metrics.

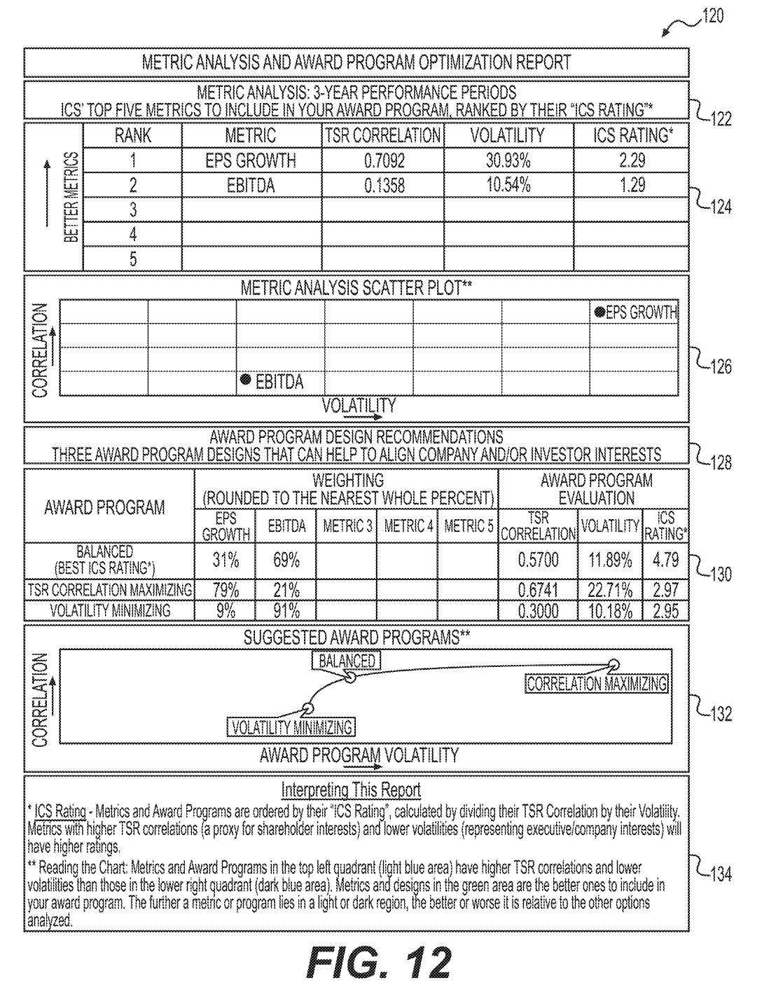

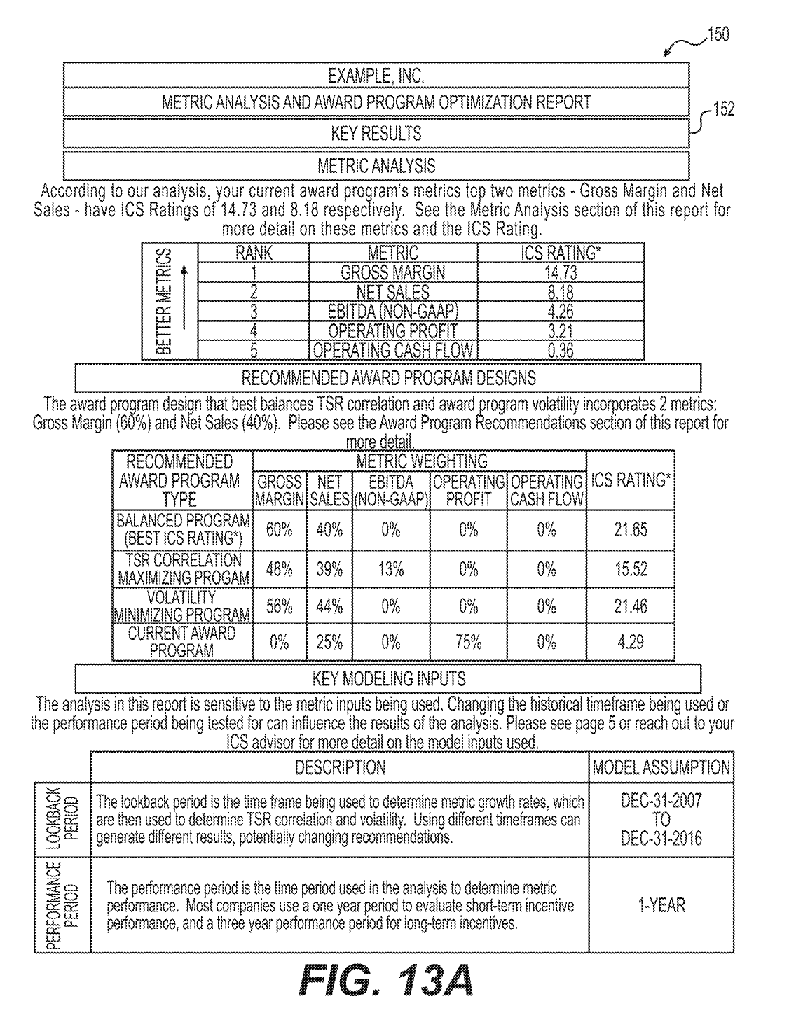

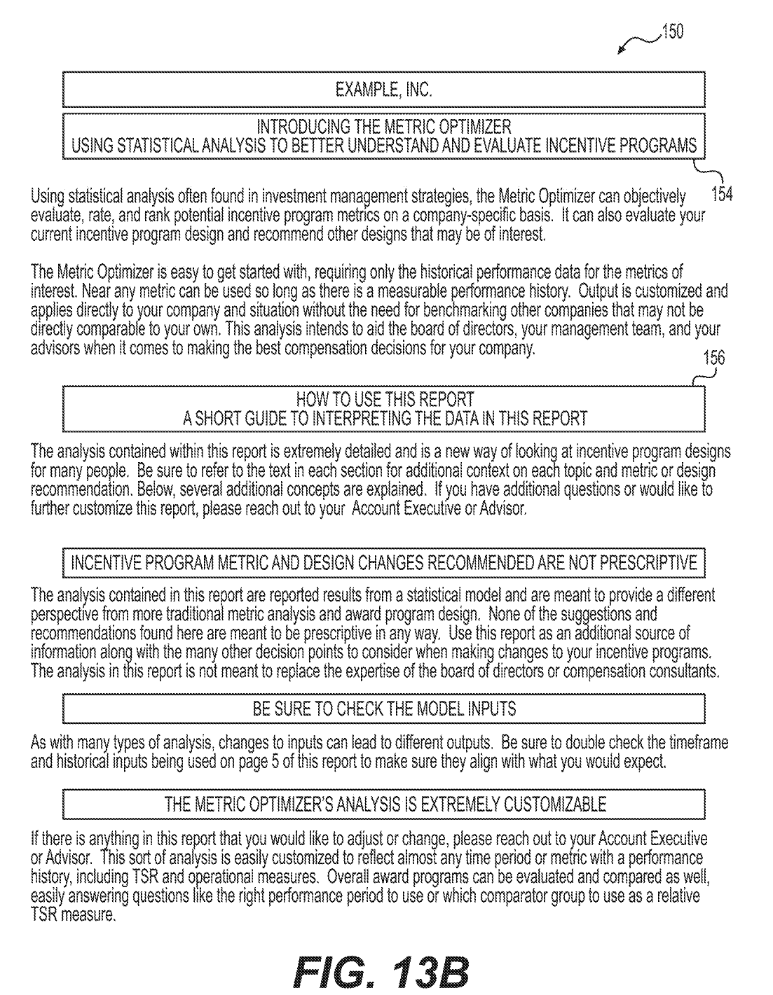

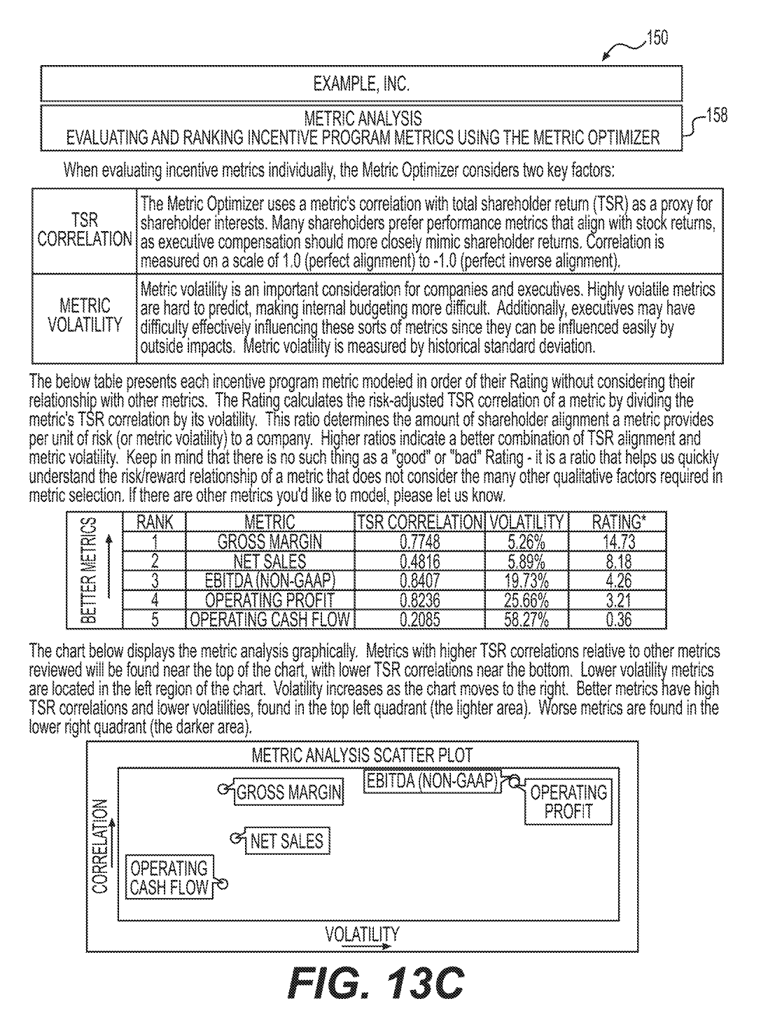

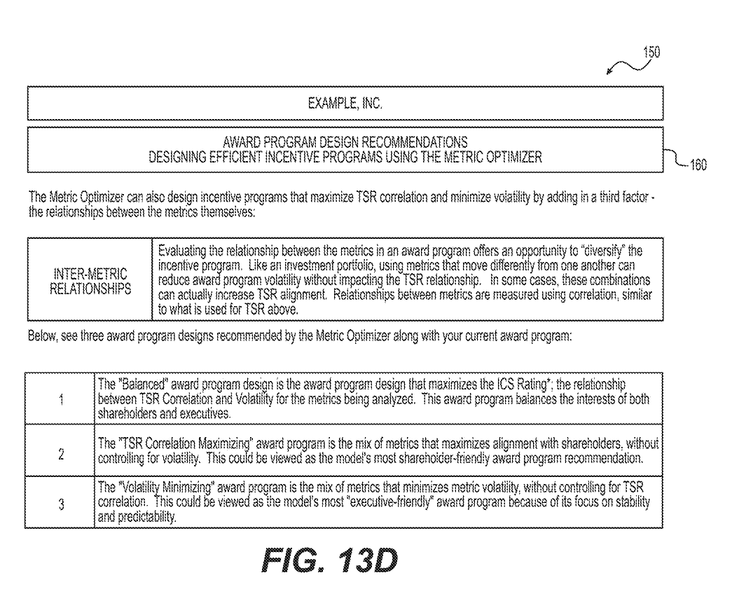

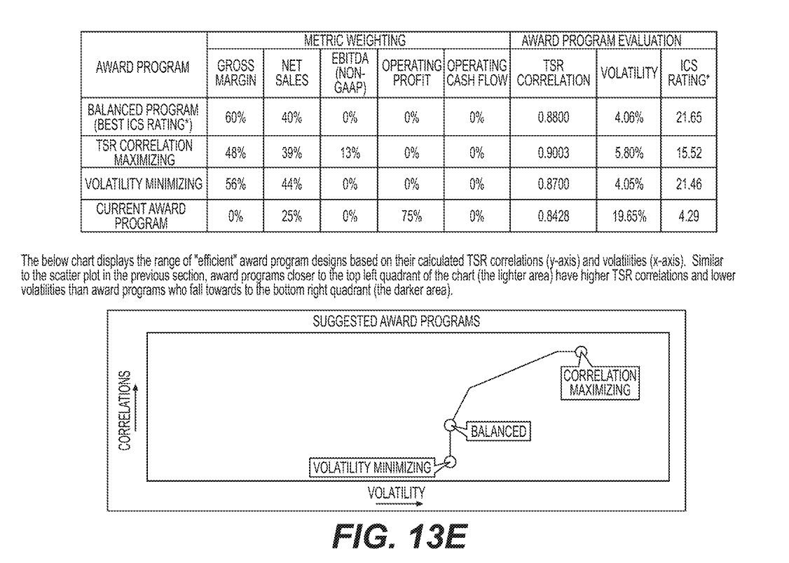

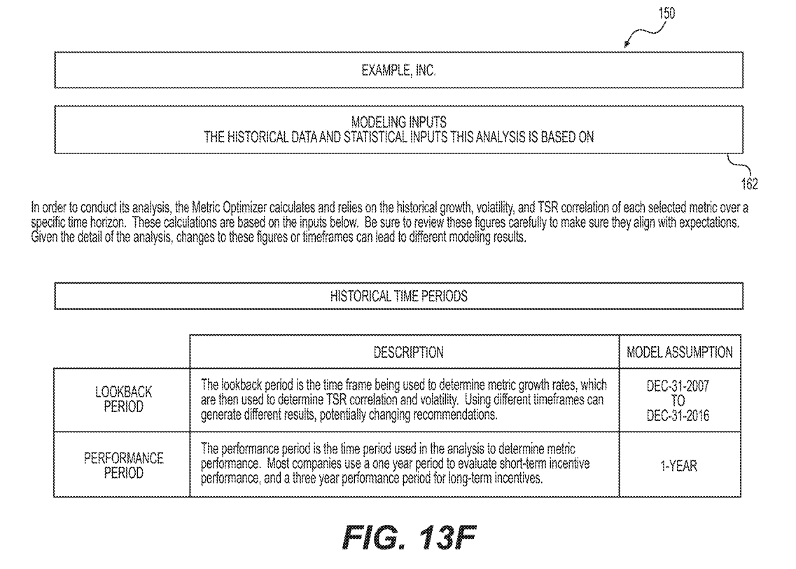

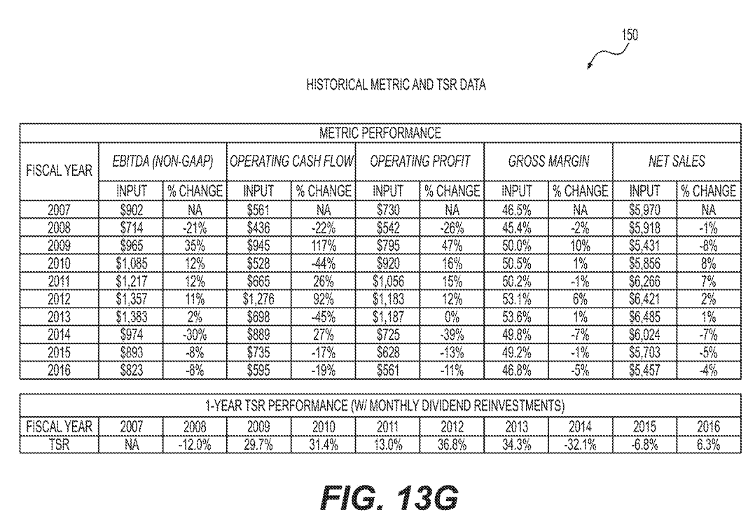

In step 220, the client portal may generate an incentive program metric recommendation 220 based on the data analysis 218 of the various inputs and internal algorithms. For example, in some embodiments the client portal may generate a recommended metric adjustment to target a different EBIT weight or generate a recommendation to increase the target value EBIT weight currently in the client's incentive program. In other embodiments, the incentive program metric recommendation 220 may be a recommended new incentive program. The recommendation, which may include recommended adjustments to an already existing program or a recommendation to implement a new incentive program, may be in the form of an electronic message displayed in the client portal 210, an e-mail, text message, PDF document transmitted to client, a message transmitted to client mobile devices, a recommendation report available for download in the client portal, or other form of electronic communication. FIGS. 12 and 13A-13G illustrate two exemplary recommendation reports that may be generated using the system and methods disclosed herein, such as an output of the client portal 210.

In step 222, the recommendations for the client's incentive program are uploaded to platform server systems that may be accessible to the client via the client portal 210. The client portal 210 may periodically update based on various inputs 202, 204, 208 and recalculate incentive program metric recommendations to upload to platform server systems of the client portal.

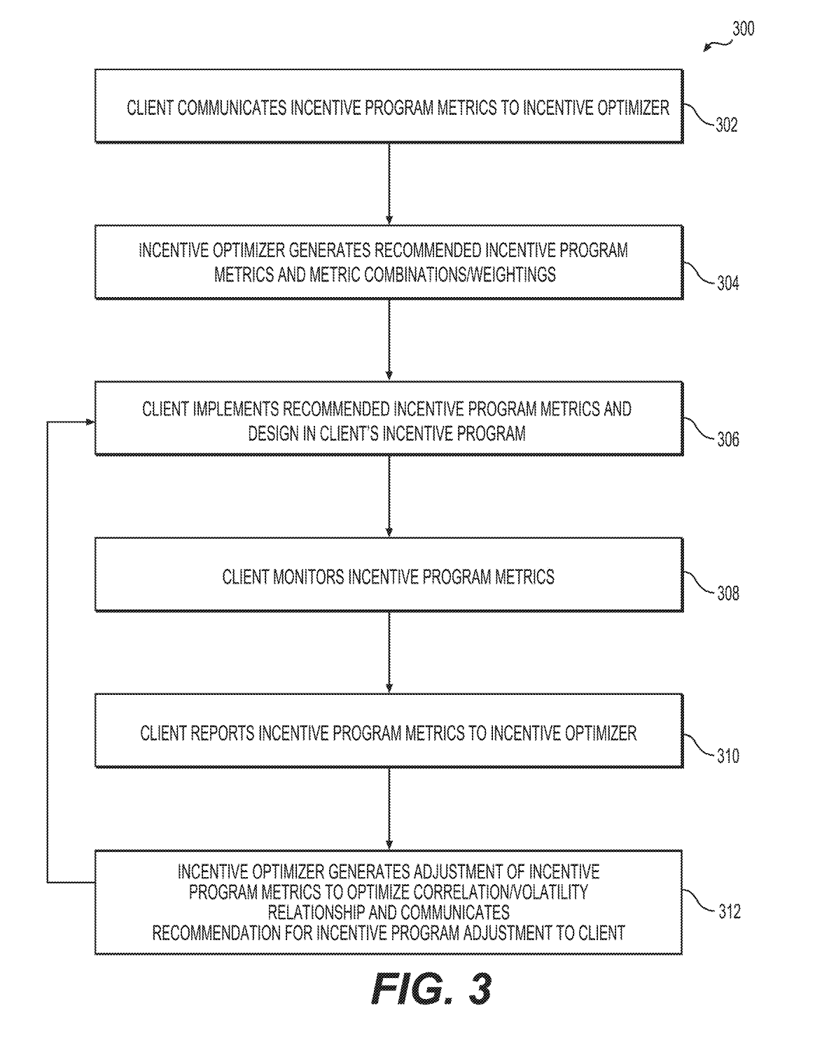

FIG. 3 shows another exemplary method of providing real-time incentive program optimization to a client. Similar to the method shown in FIG. 1, FIG. 3 shows a method that may be completed internally via a client's intranet utilizing an incentive optimizer. The incentive optimizer may include algorithms to optimize awards program metrics, databases of the client's historical metric data, client shareholder value data transmitted to the incentive optimizer over the Internet, and a dynamic user interface accessible over a network. In step 302, the client communicates incentive program metrics (such as revenue or EBIT, EPS, etc.) and the incentive optimizer generates recommended incentive program metrics and target weights for those metrics based on the client's goals (step 304). The incentive optimizer may be run through an employee internal network, may be operated without the service provider, and may be integrated into the client's internal network systems. The client may continually monitor (step 308) and input (step 310) awards program metric values into the incentive optimizer, such as through a dynamic user interface, and the incentive optimizer may generate recommended adjustments to the incentive program metrics to meet client goals (step 312). The incentive optimizer may generate incentive program criteria including the introduction of new/different metrics and/or changing the weights of incentive program metrics. The incentive optimizer may include algorithms to weigh the volatility of an awards program metric against the metric's correlation to TSR based on historical data provided by client, current metric growth, and sourced databases downloaded from the Internet, such as historical stock prices or revenue data of a client's company or of an industry. Volatility may be measured by standard deviation, which may represent the dispersion of the metrics percentage change around the average percentage change over the time period (for example, dispersion of the metrics percentage change around the average percentage change over a three year period). The incentive optimizer may calculate an optimized target metric value for an awards program metric based on the client's selection of risk (volatility) tolerance and metric goals (such as revenue targets or target TSR). The incentive optimizer may provide a client with real-time access to awards program metric optimization without the use of a service provider.

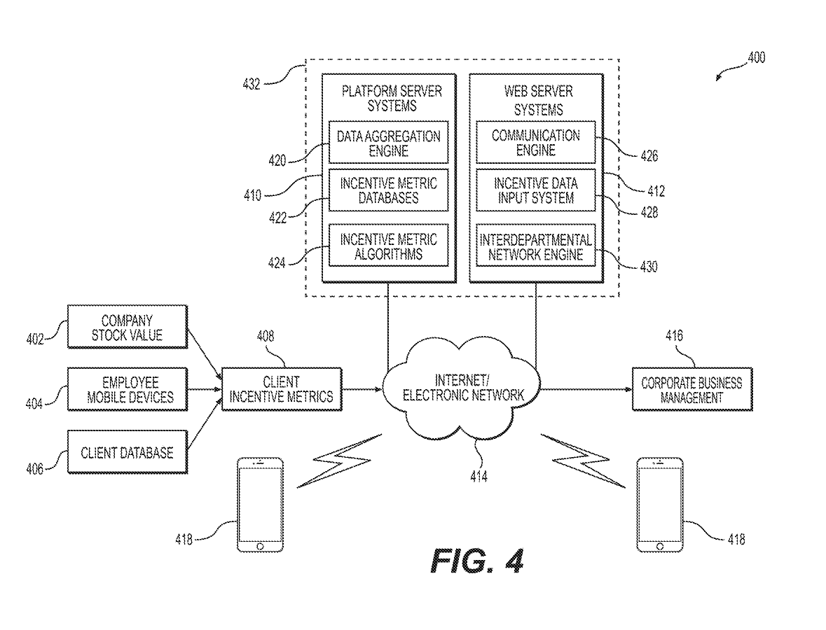

FIG. 4 is a block diagram of an exemplary environment 400 and electronic network 414 for processing client incentive metric data 408, according to an exemplary embodiment of the present disclosure. The environment 400 may include an online metric optimization platform 432 provided in communication with the Internet 414. The online metric optimization platform 432 may include, for example, platform server systems 410 and web server systems 412. Online platform server systems 410 may communicate with web server systems 412 through the Internet 414 or any other electronic network system. In one embodiment, platform server systems 410 and web server systems 412 may be operated by a common owner, or fully owned and operated by a single corporate entity. In another embodiment, one or both of platform server systems or web server systems may be outsourced to an Internet vendor. In some examples, a dynamic user interface may communicate with or be part of online metric optimization platform 432.

Environment 400 may also include client employees which interact with platform server systems 410, web server systems 412, and client's corporate business management 416 over the Internet 414 through computers or mobile devices connected to the Internet 414. In general, client employees or client's management team 416 may communicate with the online metric optimization platform 432 over the Internet 414 to perform the exemplary awards metric optimization methods disclosed herein. For example, client employees may send information about their awards program metrics, such as quarterly EBIT or quarterly average revenue growth, to platform server systems 410, e.g. by interacting with websites executed by web server systems 412. In turn, the online metric optimization platform 432 may send information about recommended awards program metric adjustment to client employees or client corporate business management 416 upon request, all through the Internet. In some embodiments, platform server systems 410 may generate a recommended incentive program based on client incentive metrics 408 sent by client employees over the internet without the client having an incentive program.

Client employees or client corporate business management 416 may implement any type or combination of computing systems 418, such as personal computers, mobile devices, clustered computing machines, and/or servers when interacting with the online metric optimization platform 432. In one embodiment, each computing system may be an assembly of hardware, including a memory, a central processing unit (“CPU”), and/or a user interface. The memory may include any type of RAM or ROM embodied in a physical storage medium, such as magnetic storage including hard disk or magnetic tape; semiconductor storage such as solid state disk (SSD) or flash memory; optical disc storage; or magneto-optical disc storage. The CPU may include one or more processors for processing data according to instructions stored in the memory. The function of the processor may be provided by a single dedicated processor or by a plurality of processors. Moreover, the processor may include, without limitation, digital signal processor (DSP) hardware, or any other hardware capable of executing software. The user interface may include any type or combination of input/output devices, such as a display monitor, touchscreen, keyboard, and/or mouse. Mobile devices used by client employees or client corporate business management 416 may be configured to access wireless digital data, telephone, and/or Internet access through any other wireless communication medium, such as, for example, local or wide area Wi-Fi or Bluetooth connectivity. Mobile devices may include any type or combination of mobile phones, personal digital assistants (“PDAs”), so-called “smartphones,” tablet PC computers, or any other mobile device configured to receive communications, and display data to a user.

As shown in FIG. 4 and discussed above, client incentive metrics 408 may include data including a client's company stock value 402, data uploaded through employee computing devices 418 such as mobile devices 404 or computers, or data uploaded from client databases 406 such as historical revenue database. Client incentive metrics 408 may be transmitted through an electronic network 414, which may include the Internet, or any other wired or wireless network. An online metric optimization platform 432 including platform server systems 410 and web server systems 412 may be operated by a service provider that may periodically update these systems to adjust their data processing capabilities. In general, a client may interact with the online metric optimization platform 432 over the Internet.

Platform server systems 410 and/or web server systems 412 of the online metric optimization platform 432 may implement any type or combination of computing systems, such as personal computers, clustered computing machines, and/or servers. In one embodiment, each computing system may be an assembly of hardware, including memory, a central processing unit (“CPU”), and/or user interface. The memory may include any type of RAM or ROM embodied in a physical storage medium, such as magnetic storage including hard disk or magnetic tape; semiconductor storage such as solid state disk (SSD) or flash memory; optical disc storage; or magneto-optical disc storage. The CPU may include one or more processors for processing data according to instruction stored in the memory. The function of the processor may be provided by a single dedicated processor or by a plurality of processors. Moreover, the processor may include, without limitation, digital signal processor (DSP) hardware, or any other hardware capable of executing software.

In one embodiment, one or more processors of the platform server systems 410 may execute a data aggregation engine 420 and/or incentive metric algorithms 424 according to instructions stored in one or more memory devices of the platform server systems 410. In addition, the platform server systems 410 may store data received from one or more of the client employees, client databases 406, or company stock values 402 in one or more incentive metric databases 422. For example, incentive metric databases 422 may store client incentive metric values for employees or overall department or company incentive metrics such as total earnings, growth in earnings, EBIT or EBIT growth. Incentive metric databases 422 may also store information relating to an organization's stock value, TSR, risk information, metric volatility information, or the like. Stored data in the incentive metric databases 422 may be aggregated by the data aggregation engine 420.

For example, the data aggregation engine 420 may calculate average metric values over specific periods of time (performance periods), metric volatility, TSR correlation to client provided incentive metric data, growth rate volatility, and other metric relationships. Metric volatility may be calculated using a standard of deviation calculated from a historical database of metric values (which may be stored in incentive metric databases 410) and comparing the range of values between a calculated standard of deviation of the dataset. Correlation of two incentive metric values may be calculated by the data aggregation engine 420 and may reflect the tendency of two metric values to move together. Correlation of two incentive metrics may be stored in incentive metric databases 422 and may be values between −1 and 1, with −1 meaning the two metrics are directly inversely correlated (when one metric increases the other metric decreases) and with 1 meaning the two metrics are directly correlated (when one metric increases the other increases). The data aggregation engine 420 may further calculate and store values of incentive metric data correlation to TSR (D_{TSR}) and volatility of incentive metric (D_{V}), and further calculate and store the ratio of D_{TSR}: D_{V}. Incentive metric algorithms 424 may include using mean-variance optimization to select an optimized group of compensation program metrics after calculating the expected risk and shareholder return correlation for each metric using the data aggregation engine 420 and incentive metric databases 422. Incentive metric algorithms 424 may further include calculating a ratio of metric/TSR correlation (determined by calculating the correlation of revenue growth, expected sales growth, etc. to TSR) relative to unit of risk, which can be calculated by dividing a metric portfolio's overall expected TSR correlation by its overall volatility (risk).

In addition, one or more processors of the web server systems 412 may execute a communication engine 426 or interdepartmental network engine 430 according to instructions stored in one or more memory devices of the web server systems 412. For example, web server systems 412 may execute a communication engine 426 for transmitting and receiving information to and from client employees or corporate business management 416. Communication engine 426 may provide mechanisms for generating automated messages, and scheduling the timing and sending of those messages to corporate business management 416 or client employees. Communication engine 426 may also provide mechanisms for receiving messages from client employees or corporate business management 416, and forwarding those messages, or data from those messages, to platform server systems 410, for execution by data aggregation engine 420 and/or incentive metric algorithms 424 and/or storage in incentive metric databases 410.

In one embodiment, incentive metric algorithms 424 includes performing incentive metric analysis, such as weighing metrics in order to compare each metric, evaluates volatility of each metric compared to TSR correlation, and optimizes client selected goal metrics (may be provided in client databases 406). The optimized client selected goal metrics, which may include additional metrics selected from incentive metric algorithms 424, may then be communicated to client management or client employees over the Internet via a communication engine 426 of a web server system 412. For example, a client may provide to the online metric optimization platform 432 (via upload or interaction with portal over the Internet) target or milestone EBIT, TSR and revenue growth values for a given quarter, and the platform 432 may process the metric goals and recommend a set of compensation metrics to use to help achieve the selected goals. In other embodiments, the platform 432 may analyze historical metric data provided in client incentive metrics 408 to generate an incentive program including selecting and weighing the metrics used in the incentive program.

In some examples, incentive metric algorithms 424 may include performing comparisons between a particular user's selected organization's metrics to other organizations, such as comparing a company's metrics to other specific companies within a particular industry, company size range, company age, and/or company location. For example, a user may upload industry data on sales or stock values for a group of companies within a particular industry, and the metric optimization platform 432 may utilize the industry specific data and provide comparisons or target thresholds for particular metrics based on the industry specific data. In some examples, the metric optimization platform 432 may provide analysis over a particular time period and provide recommendations and information related to a particular metric's correlation to TSR or any other metric over time, such as showing how a metric's correlation to TSR has changed over a user-selected number of years. In some examples, the metric optimization platform 432 may output weightings of metric quality and/or appropriateness compared to peer companies, a particular industry, an index such as a stock price index, and/or a location or region. In some examples, the metric optimization platform 432 may output suggestions for new metrics to use in an incentive program to improve performance and/or move towards a user selected goal.

In some examples, a user may input a hypothetical scenario with various metric values based on the hypothetical scenario, and the metric optimization platform 432 may provide comparisons of metric values in the hypothetical scenario, may provide recommendations on how to adjust a program to reach a hypothetical scenario, may predict metric values under such a hypothetical scenario, and/or provide a ranking or suggestion for a particular hypothetical scenario after a user inputs a plurality of scenarios. In some examples, the metric optimization platform 432 may evaluate incentive program designs and provide recommendations for how to adjust an incentive program design to reach user-selected goals based on prior incentive program design data and current metric data inputs. The metric optimization platform 432 may also predict incentive program design effectiveness for any period of time, such as for the next five years or for the past five years. In some examples, the metric optimization platform 432 may allow the user to input assumption data and output recommendations for metric selection and/or adjustment for an incentive program accounting for the user-selected assumption data. For example, a user may input an assumed total revenue and total increase in sales over the next five years into the metric optimization platform 432 and the platform 432 may output recommendations based on those assumptions.

In some examples, the metric optimization platform 432 may evaluate the quality and/or appropriateness of different metrics within a user selected incentive program and may provide rankings of the effectiveness of the incentive program and/or the effectiveness of each metric used within a particular incentive program.

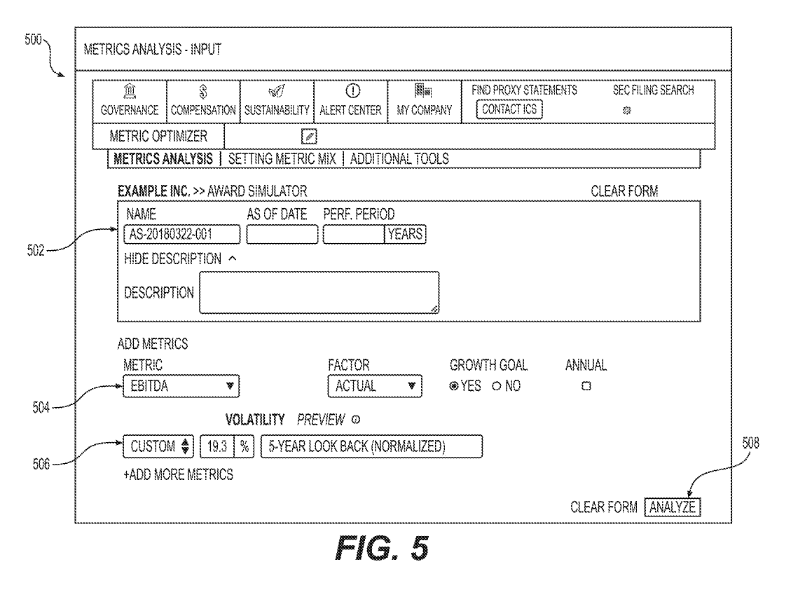

FIG. 5 shows an exemplary embodiment of a dynamic user interface 500. While FIG. 5 shows an example display page of a user application that may be created using the metric optimization platform 432, it should be understood that any software application using graphical user interfaces may be generated with techniques presented herein. Dynamic user interface 500 may, for example, display an program name creator 502 which may enable a user to define certain parameters of a metric program analysis, such as a start date and performance period for a particular program in which the user would like the metric optimization platform 432 to analyze. In some examples, a metric selector 504 may provide a list of metrics the user may select and may allow the user to adjust how each selected metric is weighted, such as by a particular factor as shown in FIG. 5. In addition to selecting particular metrics in the metric selector 504, dynamic user interface 500 may also include metric volatility selector 506 to provide a means for users to select particular metrics to be analyzed for volatility over a particular timer period. Once the user has selected the desired parameters, such as metrics to be analyzed, volatility, performance period, etc., the user may select the analyze 508 function to initiate analysis of the selected metric parameters using the metric optimization platform 432. Dynamic user interface 500 may be accessed and/or displayed via any type of computing system 418.

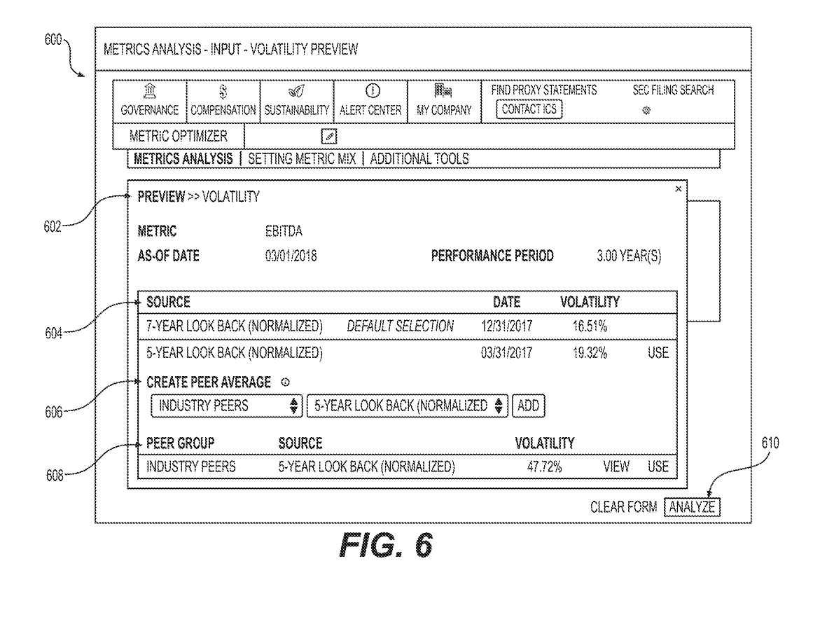

FIG. 6 shows another exemplary embodiment of a dynamic user interface 600 including a display of a volatility preview 602 for a particular metric during a user-specified performance period. In some examples, the user may adjust the source 604 of data that the metric optimization platform 432 may use to analyze the selected metrics, may select datasets from other sources such as selecting create peer average 606, and may select one or more peer groups 608 for the metric optimization platform 432 to utilize when generating recommendations and/or analysis. Peer averages and peer groups may be uploaded by a user or may be incorporated into databases within the metric optimization platform. To execute an analysis of the selected metrics and parameters, a user may select analyze 610 to initiate the generation of recommendations and/or analysis by metric optimization platform 432.

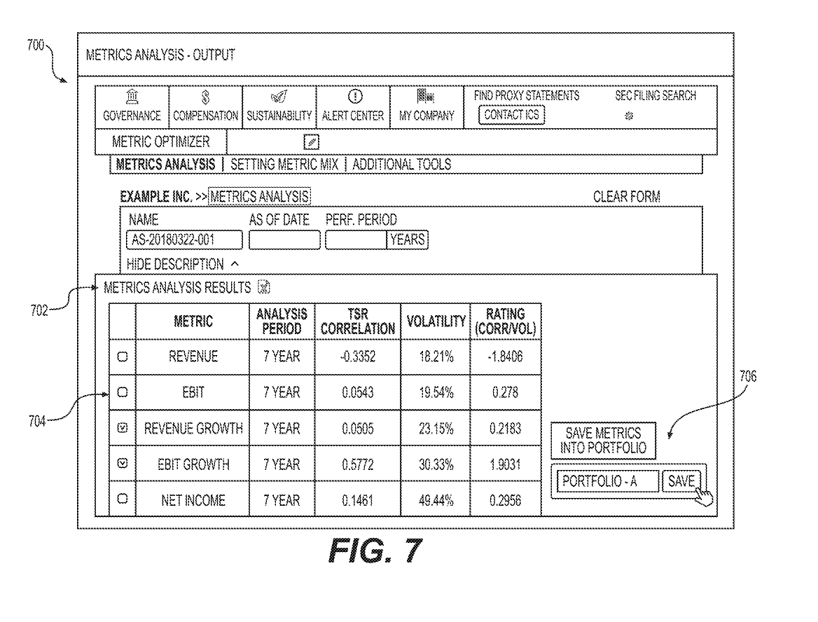

FIG. 7 shows an exemplary embodiment of a dynamic user interface 700 displaying an example of a metric analysis output generated by a metric optimization platform 432. Metric analysis results 702 may be displayed in dynamic user interface 700, and may show a list of metrics 704 with information regarding the metric analysis, such as the analysis period, TSR correlation, volatility, and rating (i.e. TSR correlation/volatility). In some examples, the user may select a save function 706 to save the metrics analysis results 702 via any type of computing system 418.

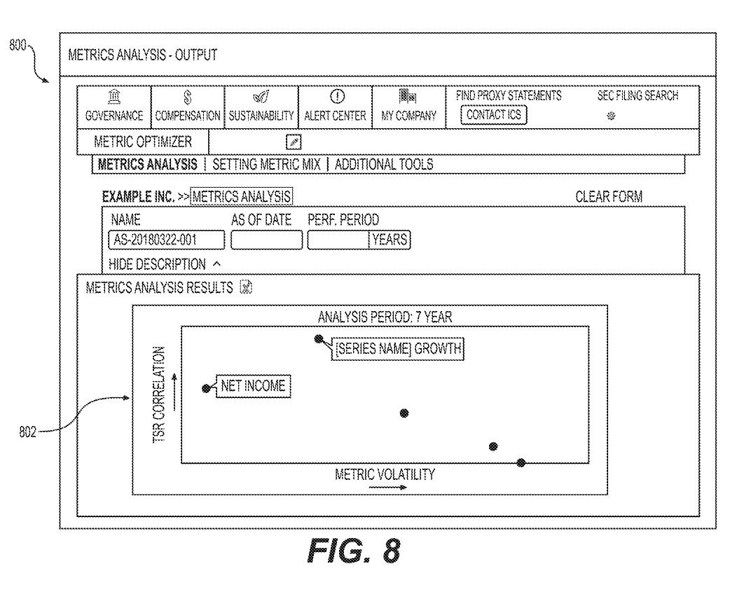

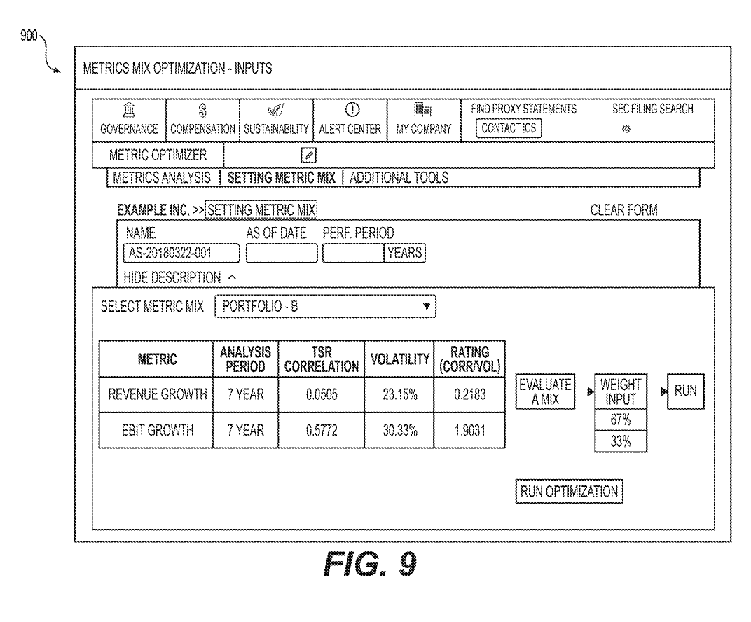

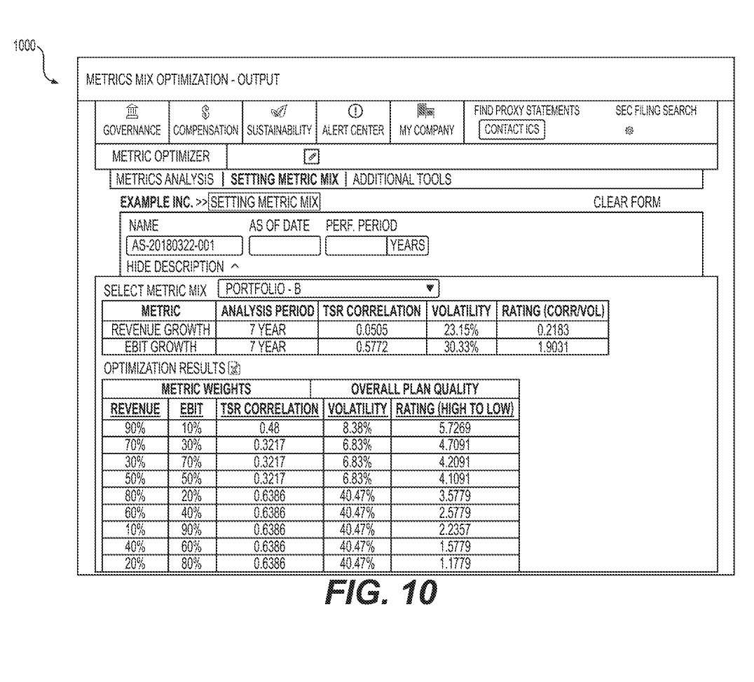

FIG. 8 shows another exemplary embodiment of a dynamic user interface 800 displaying an example of a metric analysis output generated by a metric optimization platform 432. In some examples, metric optimization platform 432 may generate a graph 802 displaying an “efficient frontier” plotting a metric's volatility with the metrics TSR correlation. Graph 802 may display the optimal weight for each metric to minimize risk for each potential level of metric portfolio return, where each optimal point is represented by a point on the graph. Exemplary dynamic user interface 900, shown in FIG. 9, includes an option for a user to select a mix of metrics from saved metric portfolios to run optimizations using metric optimization platform 432 of a number of different saved metric data sets. FIG. 10 illustrates the results of an example of selected metric portfolios analyzed using metric optimization platform 432 and displayed in dynamic user interface 1000.

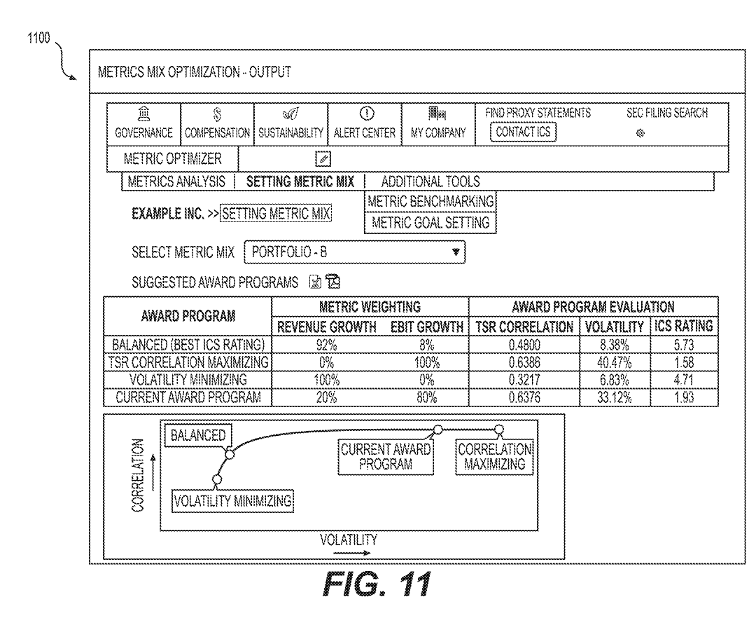

FIG. 11 shows another exemplary dynamic user interface 1100 displaying a metrics mix optimization output generated by metric optimization platform 432. As shown in FIG. 11, some examples of an output of metric optimization platform 432 include both a display of the selected award programs with relevant metric weighting and award program evaluation, along with a graph of volatility versus ISR correlation with particular program optimization points labeled for specific goals (such as volatility minimizing, balanced, current award program, and correlation maximizing).

FIG. 12 shows an exemplary Metric Analysis and Award Program Optimization Report 120 generated by the metric optimization platform 432. Report 120 may be uploaded to a dynamic user interface to allow the user to download and/or access the report. In some examples, Report 120 may be periodically updated using data uploaded to a dynamic user interface by the user and/or a service provider. In some examples, Report 120 may include one or more sections including a Metric Analysis section 122 including a metric ranking chart 124, a Metric Analysis Scatter Plot 126 plotting metric volatility with correlation to a selected metric (such as TSR), an Award Program Design Recommendations section 128 including a chart of different award programs metric data, a graph of suggested award programs 132 plotting award program volatility versus correlation to a selected metric (such as TSR), and an Interpreting This Report section 134 detailing how the user should use Report 120.

FIGS. 13A-G show an exemplary Metric Analysis and Award Program Optimization Report 150 according to aspects of the present disclosure. In some examples, Metric Analysis and Award Program Optimization Report 150 may include one or more sections including Key Results 152, Introducing the Metric Optimizer Using Statistical Analysis to Better Understand and Evaluate Incentive Programs 154, How to Use This Report 156, Metric Analysis 158, Award Program Design Recommendations 160, and Modeling Inputs 162. Reports 120, 150 may include recommended actions for a user to take in order to maximize or increase a compensation program's correlation to TSR or any other metric or plurality of metrics selected by the user. Report 150 may include data relating to any of the metrics discussed herein.

The presently disclosed systems and methods provide an online incentive program metric generating, monitoring and optimizing platform that allows: (i) individual client employees to input specific award program metric data or potential award metric historical data via the Internet; (ii) client business managers to adjust incentive program metrics and targets based on real-time optimization and recommendations provided over the Internet; and (iii) client corporate managers to create or adjust incentive program goals based on platform generated recommendations and receive real-time recommended adjustments for incentive program metric selections, weights, target values. In addition, the presently disclosed systems and methods provide a means to correlate TSR or volatility with incentive program metric and target values and communicating over the Internet recommendations based on metric correlations, facilitating corporate decision-makers in developing incentive programs that align with shareholder value.

The presently disclosed systems and methods offer an electronic platform for businesses to better create and/or evaluate their compensation incentive programs and facilitate aligning of compensation program metric goals with shareholder return. The disclosed systems and methods provide an online system for periodic feedback and monitoring of incentive program metrics, metric volatility, alignment with other metrics, organization goals and shareholder returns, and give organizations a means to easily access incentive program recommendations, metric optimization recommendations and metric tracking over the Internet.

What is claimed is:

1. A computer-implemented method for online resource program optimization, the method comprising:
receiving, over a network and from an organization representative, information relating to resource program metrics and organization's goals;
using a processor to:
analyze the information relating to the organization's resource program;
optimize the relationship of correlation and volatility between the information and one or more historical resource program metric data sets; and
generate recommended resource program criteria;
transmitting the recommended adjustment of resource program criteria over the network; and
receiving payment from a representative of the organization, the payment being provided in consideration for the recommended adjustment of the resource program criteria.

2. The computer-implemented method of claim 1, wherein analyzing includes performing mean-variance analysis of risk and total shareholder return correlation of each resource program metric and combinations of these metrics.

3. The computer-implemented method of claim 1, wherein analyzing includes receiving over the Internet information relating to an organization's stock value.

4. The computer-implemented method of claim 1, wherein generating a recommended adjustment of the resource program includes generating a report on the changes in metrics and metric weightings suggested for the resource program.

5. The computer-implemented method of claim 1, the method further comprises:
prior to using the processor to analyze the information relating to the organization's resource program, uploading to a database historical data relating to resource program metrics, wherein the database is in data communication with the processor.

6. The computer-implemented method of claim 1, the method further comprising:
transmitting a metric analysis and award program optimization report over a network to a server system accessible to an organization representative, wherein the report includes a recommended adjustment of resource program criteria.

7. A computer-implemented method for online incentive program optimization, the method comprising:
receiving, over a network and from an organization representative, information relating to incentive program metrics including revenue, earnings before interest and taxes, revenue growth, earnings before interest and taxes growth, net income and organization's goals, wherein the information is inputted by the organization representative into a dynamic user interface via a computing system;
using a processor to:
analyze the information relating to the organization's incentive program;
optimize the relationship of correlation and volatility between the information and total shareholder return; and
generate recommended incentive program criteria;
transmitting the recommended adjustment of incentive program criteria over the network; and
receiving payment from a representative of the organization, the payment being provided in consideration for the recommended adjustment of incentive program criteria.

8. The computer-implemented method of claim 7, wherein analyzing includes performing mean-variance analysis of risk and TSR correlation of each incentive program metric and combinations of these metrics.

9. The computer-implemented method of claim 7, wherein analyzing includes receiving over the Internet information relating to an organization's stock value.

10. The computer-implemented method of claim 7, wherein generating a recommended adjustment of incentive program includes generating a report on the changes in metrics and metric weightings suggested for the compensation program.

11. The computer-implemented method of claim 7, wherein the dynamic user interface is accessed by the organization's representative using a computing system connected to a private electronic network.

12. The computer implemented method of claim 7, wherein transmitting the recommended adjustment of incentive program criteria over the network includes displaying a graph of the incentive program metrics versus the metrics correlation to total shareholder return within the dynamic user interface.

13. The computer implemented method of claim 7, wherein transmitting the recommended adjustment of incentive program criteria over the network includes displaying a quality rating for each incentive program metric.

14. The computer implemented method of claim 7, wherein the dynamic user interface comprises a web platform accessible over the Internet, a mobile platform accessible via a mobile device, or a private server platform accessible via user's internal intraweb.

15. A system for online optimization of compensation program metrics, the system comprising:
a physical storage media storing instructions for optimizing compensation program metrics; and
a processor configured for:
receiving, over a network and from an organization with a compensation program, information relating to the compensation program;
analyzing the information relating to the compensation program;
generating recommended adjustments to the compensation program;
transmitting the recommended adjustments to the compensation program to the organization over the network; and
receiving payment from the organization, the payment being provided in consideration for the interest in the recommended adjustments to the compensation program.

16. The system of claim 15, wherein analyzing includes (1) calculating the correlation between compensation program metrics and total shareholder return for the organization, (2) calculating the historical volatility of compensation metrics, (3) evaluating relationships between metric TSR correlation and metric volatility, and (4) determining the metrics that maximize TSR correlation and minimize metric volatility.

17. The system of claim 15, wherein the process is further configured for displaying the recommended adjustments to the compensation program in a dynamic user interface accessible to the organization.

18. The system of claim 15, wherein receiving information relating to the compensation program further includes receiving historical metric data relating to the organizations compensation program and historical metric data of at least one other organization.

19. The system of claim 15, wherein transmitting the recommended adjustments to the compensation program to the organization over the network includes transmitting at least one Matric Analysis and Award Program Optimization Report over the network.

20. The system of claim 15, wherein receiving, over a network and from an organization with a compensation program, information relating to the compensation program includes receive information transmitted from a dynamic user interface.
